(19) United States
(12) Patent Application Publication
(10) Pub. No.: US 2012/0260923 A1
(43) Pub. Date: Oct. 18, 2012

(54) Apparatus and Method for Migrating Anatomic Parts

(75) Inventor: Michael Campagna, Oak Park, IL (US)

(73) Assignee: DESIGN MD LLC., Libertyville, IL (US)

(21) Appl. No.: 13/174,703

(22) Filed: Jun. 30, 2011

Related U.S. Application Data
(60) Provisional application No. 61/421,586, filed on Dec. 9, 2010.

(51) Int. Cl. A61G 15/00

(52) U.S. Cl. 128/845

(57) ABSTRACT

An apparatus has an anatomic positioner for migrating an anatomic part. The anatomic positioner has a mechanism for joining the apparatus to a side of a patient platform. A support member joins to the mechanism and extends longitudinally along the side. A breaking assembly moves longitudinally along the support member. The breaking assembly is operable to be fixed at a position along the support member. A support assembly is joined to the breaking assembly. The support assembly extends away from the breaking assembly and above a top of the patient platform. The support assembly positions a portion of the support assembly at a location above the top and fixes the portion at the location. A rigid member has an end portion and an engaging end. The end portion is joined to the portion of the support assembly. The engaging end engages the anatomic part and applies a pushing force thereupon.

### CROSS-REFERENCE TO RELATED APPLICATIONS

The present Utility patent application claims priority benefit of the U.S. provisional applications for patent Ser. No. 61/421,586 entitled “An Improved Method for Radiographic Visualization of the Cervical Vertebral Column”, filed on 9 Dec. 2010, and patent Ser. No. 61/098,757 entitled “Universal Table Mount for the Citow Cervical Visualizer”, filed on 20 Sep. 2008 under 35 U.S.C. 119(e).

The present Utility patent application also claims priority benefit under 35 U.S.C. 120 of Utility patent application Ser. No. 12/464,456 entitled “An Apparatus for Mounting an Anatomical Positioner on a Patient Care Platform”, filed on 12 May 2009 and U.S. Continuation-in-part patent application Ser. No. 12/684,934 entitled “Apparatus and Method for Radiolucent Anatomic Positioning” filed on 9 Jan. 2010 under 35 USC 111(a). The contents of these related provisional and patent applications are incorporated herein by reference for all purposes.

### FEDERALLY SPONSORED RESEARCH OR DEVELOPMENT

Not applicable.

### REFERENCE TO SEQUENCE LISTING, A TABLE, OR A COMPUTER LISTING APPENDIX

Not applicable.

### COPYRIGHT NOTICE

A portion of the disclosure of this patent document contains material that is subject to copyright protection. The copyright owner has no objection to the facsimile reproduction by anyone of the patent document or patent disclosure as it appears in the Patent and Trademark Office, patent file or records, but otherwise reserves all copyright rights whatsoever.

### FIELD OF THE INVENTION

One or more embodiments of the invention generally relate to medical equipment. More particularly, the invention relates to means for variable radiolucent anatomic positioning.

### BACKGROUND OF THE INVENTION

The following background information may present examples of specific aspects of the prior art (e.g., without limitation, approaches, facts, or common wisdom) that, while expected to be helpful to further educate the reader as to additional aspects of the prior art, is not to be construed as limiting the present invention, or any embodiments thereof, to anything stated or implied therein or inferred thereupon.

Medical procedures involving the cervical spine, particularly surgery, require correct visualization of the vertebrae during radiography procedures such as, but not limited to, X-Ray, fluoroscopy, computed tomography (CT), magnetic resonance imaging (MRI), etc. Typically, a subject's shoulders obscure the lateral imaging of the cervical vertebrae. It is therefore an objective of the present invention to provide means for positioning the subject's shoulders during radiography that migrate the shoulders out of the line of sight of the lateral image of the cervical vertebrae.

The following is an example of a specific aspect in the prior art that, while expected to be helpful to further educate the reader as to additional aspects of the prior art, is not to be construed as limiting the present invention, or any embodiments thereof, to anything stated or implied therein or inferred thereupon. By way of educational background, another aspect of the prior art generally useful to be aware of is that traditional means of shoulder migration exist to solve the problem of intra-operative shoulder migration for improved lateral radiography of the cervical vertebral structures with varying degrees of success and risk attendant to usage. One traditional means for migrating the subject's shoulders involves wrapping straps or Kurlix bandages around the forearms or wrists of a subject and pulling forcefully upon these straps or bandages during imaging. However, this means of pulling on the wrists with straps or Kurlix bandages oftentimes leads to brachial plexus insult and injury and often delivers poor results. This risk of injury is ever-present whether said traction is delivered via someone directly pulling on a wrist strap during radiography or via a mechanical version of someone pulling on a wrist strap such as, but not limited to, a weight on the end of a strap or a friction lock, which are provided in some prior art means. Mechanical versions may aggravate this risk in that no means for variable tensioning of the migratory pressure is provided in the mechanical pulling means. Pulling on the wrists or arms has the effect of transferring direct force to the soft tissues and delicate structures of the shoulder capsule, with less than efficient migration of the shoulders.

The following is an example of a specific aspect in the prior art that, while expected to be helpful to further educate the reader as to additional aspects of the prior art, is not to be construed as limiting the present invention, or any embodiments thereof, to anything stated or implied therein or inferred thereupon. By way of educational background, another aspect of the prior art generally useful to be aware of is that another traditional means of migrating a subject's shoulders involves taping down the shoulders or migrating the trapezius muscles with a cotton harness for the entirety of the imaging procedure. This oftentimes has the effect of causing brachial palsy, as neither taping nor usage of various harness systems provide a means of varying the position of the subject during the procedure, yet merely position and hold the shoulders in an unalleviated and unnatural position for the entire length of the procedure, thereby increasing the risk of nerve damage while concurrently aggravating the results through restricted blood flow to the trapezius muscles and the structures of the shoulders. Additionally, via spreading the motive force of distal migratory tension across the entire soft tissue of the shoulder, the amount of migration of the acromionclavicular joints, which are the actual structures that typically cause the dense artifact that obscures the lateral imaging of the cervical vertebrae, is ineffective since no concentration of positioning is directed to the actual joint. Furthermore, the application of distal migratory pressure across the entire shoulder and trapezius often has the effect of migrating the entire subject, or at least causing the subject's position in relation to the surgeon to migrate, which can result in substantial risk in these types of systems.

None of these traditional means utilizes a rail guided and trigger actuated migratory apparatus and more importantly none of these means utilizes rigid radiolucent positioning to migrate the acromionclavicular joint alone. Rather, many of these means either migrate the entire trapezius in a harness or pull on the wrists or arm thereby migrating the entire patient as opposed to the acromionclavicular joint, thereby rendering little actual value in real usage. Some prior art means merely compress the trapesius muscle, as opposed to migrating the structures of the acromionclavicular joint, which is also ineffective in lateral imaging applications. Also, much of the prior art does not lock into place during use, thereby necessitating that staff members are exposed to cumulative radiographic tissue load with each usage as they hold the means in place. Additionally, prior art methods make no provision for intra-operative variability of distal migration, the lack of which is clinically proven to lead to temporary and sometimes permanent brachial palsy deficit for the subject, for example, without limitation, loss of sensation in the hands, fingers and lower portions of the arm. Furthermore, many prior art methods require multiple operators for usage. Some traditional prior art means, for example, without limitation, a compression harness that holds down the trapezius muscles, not only transmit a dangerous force load to the trapezius without actually migrating the acromionclavicular joint making them ineffective with respect to facilitating lateral radiographic imaging of the cervical vertebral structures, they also may involve a complex set up which may be incompatible with the present array of patient positioning platforms. As such, traditional means of intra-operative distal migration of the shoulders are ill suited at best and introduce an unacceptable level of risk.

In view of the foregoing, it is clear that these traditional techniques are not perfect and leave room for more optimal approaches.

### BRIEF DESCRIPTION OF THE DRAWINGS

The present invention is illustrated by way of example, and not by way of limitation, in the figures of the accompanying drawings and in which like reference numerals refer to similar elements and in which:

FIG. 1 is a side perspective view of an exemplary means for positioning the shoulders of a subject for improved lateral imaging of the cervical vertebral structures;

FIGS. 2A, 2B and 2C illustrate an exemplary one-piece shoulder pusher, in accordance with an embodiment of the present invention. FIG. 2A is a diagrammatic side view. FIG. 2B is a diagrammatic top view, and FIG. 2C is a diagrammatic front view; and

FIG. 3 is a side perspective view of an exemplary shoulder positioning device for improved lateral imaging of the cervical vertebral structure of a subject, in accordance with an embodiment of the present invention.

Unless otherwise indicated illustrations in the figures are not necessarily drawn to scale.

### SUMMARY OF THE INVENTION

To achieve the forgoing and other objects and in accordance with the purpose of the invention, a variety of apparatus and methods for migrating anatomic parts are described.

In one embodiment an apparatus comprises a first anatomic positioner for migrating a first anatomic part of a patient on a patient platform. The first anatomic positioner comprises a mechanism for joining the apparatus to a first side of the patient platform. A support member is joined to the mechanism and is configured to extend generally longitudinally along the first side. A breaking assembly is configured to be operable to move longitudinally along the support member. The breaking assembly is further configured to be operable to be fixed at a position along the support member. A support assembly is joined to the breaking assembly. The support assembly is configured to extend away from the breaking assembly and above a top of the patient platform. The support assembly is further configured to be operable to position a portion of the support assembly at a location above the top and to fix the portion at the location. A rigid member comprises a first end portion and an engaging end distal to the first end portion. The first end portion is joined to the portion of the support assembly. The engaging end is configured to be operable for engaging the first anatomic part and applying a pushing force thereupon where, with the engaging end positioned to engage, the support assembly fixed, and the breaking assembly moved, the force is applied to migrate the first anatomic part. In another embodiment the engaging end of the rigid member comprises an arch shape. In yet another embodiment the engaging end comprises an arch with an eccentric curvilinear shape. In still another embodiment the breaking mechanism comprises a trigger mechanism for removably fixing at a position. In another embodiment the support assembly further comprises a first member for extending away from the breaking assembly and a second member for extending across a portion of the top. In yet another embodiment the support assembly further comprises an adjustment mechanism joining the first member and the second member. In still another embodiment the adjustment mechanism is configured to be operable to move along a longitudinal axis of the first member and a longitudinal axis of the second member. In another embodiment the second member is rotatably joined to the adjustment mechanism. In yet another embodiment the rigid member further comprises a radiolucent material. In still another embodiment the engaging end is further configured to be operable for engaging an acromioclavicular joint and caudally migrating the acromioclavicular joint. Another embodiment further comprises a second anatomic positioner for migrating a second anatomic part of a patient on the patient platform, the second anatomic positioner comprising a mirror image of the first anatomic positioner, the second anatomic positioner being joined to a second side of the patient platform.

In another embodiment an apparatus comprises a first anatomic positioner for caudally migrating a first acromioclavicular joint of a patient on a patient platform. The first anatomic positioner comprises means for joining the apparatus to a first side of the patient platform, means, being joined to the joining means, for extending generally longitudinally along the first side, means for moving along a longitudinal axis of the extending means and for removably fixing at a position along the extending means, means, being joined to the moving means, for positioning a portion at a location above a top of the patient platform and for removably fixing the portion at the location, and means, being joined to the portion, for engaging the first acromioclavicular joint and for applying a pushing force thereupon where, with the moving means moved in a caudal direction, the force is applied to caudally migrate the first acromioclavicular joint. The apparatus comprises a second anatomic positioner for caudally migrating a second acromioclavicular joint of the patient. The second anatomic positioner comprises means for joining the apparatus to a second side of the patient platform, means, being joined to the joining means, for extending generally longitudinally along the second side, means for moving along a longitudinal axis of the extending means and for removably fixing at a position along the extending means, means, being joined to the moving means, for positioning a portion at a location above the top of the patient platform and for removably fixing the portion at the location, means, being joined to the portion, for engaging the second acromioclavicular joint and for applying a pushing force thereupon where, with the moving means moved in a caudal direction, the force is applied to caudally migrate the second acromioclavicular joint to provide a clear radiographic lateral imaging of the cervical vertebral structures of the patient.

In another embodiment an apparatus comprises a first anatomic positioner for caudally migrating a first acromioclavicular joint of a patient on a patient platform. The first anatomic positioner comprises a mechanism for joining the apparatus to a first side of the patient platform. A support member is joined to the mechanism and is configured to extend generally longitudinally along the first side. A breaking assembly comprises a break mechanism. The breaking assembly is configured to move along a longitudinal axis of the support member. The break mechanism is configured to be operable to removably fix the breaking assembly at a position along the support member. A support assembly is joined to the breaking assembly. The support assembly comprises a first member for extending away from the breaking assembly and a second member for extending across a portion of the top. The support assembly is further configured to be operable to position a portion of the second member at a location above the top and to removably fix the portion at the location. A rigid member comprises a radiolucent material and comprises a first end portion and an arch distal to the first end portion with an eccentric curvilinear shape. The first end portion is joined to the portion of the second member. The arch is configured to be operable for engaging the first acromioclavicular joint and applying a pushing force thereupon where, with the arch positioned to engage, the support assembly fixed, and the breaking assembly moved in a caudal direction, the force is applied to caudally migrate the first acromioclavicular joint. The apparatus further comprises a second anatomic positioner for caudally migrating a second acromioclavicular joint of the patient. The second anatomic positioner comprises a mechanism for joining the apparatus to a second side of the patient platform. A support member is joined to the mechanism and is configured to extend generally longitudinally along the second side. A breaking assembly comprises a break mechanism. The breaking assembly is configured to move along a longitudinal axis of the support member. The break mechanism is configured to be operable to removably fix the breaking assembly at a position along the support member. A support assembly is joined to the breaking assembly. The support assembly comprises a first member for extending away from the breaking assembly and a second member for extending across a portion of the top. The support assembly is further configured to be operable to position a portion of the second member at a location above the top and to removably fix the portion at the location. A rigid member comprises a radiolucent material and comprises a first end portion and an arch distal to the first end portion with an eccentric curvilinear shape. The first end portion is joined to the portion of the second member. The arch is configured to be operable for engaging the second acromioclavicular joint and applying a pushing force thereupon where, with the arch positioned to engage, the support assembly fixed, and the breaking assembly moved in a caudal direction, the force is applied to caudally migrate the second acromioclavicular joint to provide a clear radiographic lateral imaging of the cervical vertebral structures of the patient. In another embodiment the break mechanism comprises a trigger mechanism for operating the break mechanism.

In another embodiment a method of using the apparatus comprises steps of joining the joining mechanism of the first anatomic positioner to the side of the patient platform. The method further comprises the step of moving the breaking assembly in a cranial direction to an end of the support member. The method further comprises the step of operating the support assembly to position the engaging end of the rigid member to engage the first anatomic part. The method further comprises the step of fixing the position of the support assembly. The method further comprises the step of pushing on the breaking assembly to caudally migrate the first anatomic part. The method further comprises the step of fixing the position of the breaking assembly when the first anatomic part has been migrated. Another embodiment further comprises the step of placing an arch of the engaging end on a shoulder area of the patient above an acromioclavicular joint. Yet another embodiment further comprises the step of operating a trigger mechanism for fixing a position of the breaking assembly. Still another embodiment further comprises steps of joining a joining mechanism of a second anatomic positioner to a second side of the patient platform. The method further comprises the step of moving a breaking assembly of the second anatomic positioner in a cranial direction to an end of a support member of the second anatomic positioner. The method further comprises the step of operating a support assembly of the second anatomic positioner to position an engaging end of a rigid member of the second anatomic positioner to engage a second anatomic part. The method further comprises the step of fixing the position of the support assembly of the second anatomic positioner. The method further comprises the step of pushing on the breaking assembly of the second anatomic positioner to caudally migrate the second anatomic part. The method further comprises the step of fixing a position of the breaking assembly of the second anatomic positioner when the second anatomic part has been migrated. Another embodiment further comprises the step of placing an arch of the engaging end of the rigid member of the second anatomic positioner on a second shoulder area of the patient above a second acromioclavicular joint. Yet another embodiment further comprises the step of operating a trigger mechanism of the second anatomic positioner for fixing a position of the breaking assembly of the second anatomic positioner.

Other features, advantages, and objects of the present invention will become more apparent and be more readily understood from the following detailed description, which should be read in conjunction with the accompanying drawings.

### DETAILED DESCRIPTION OF THE PREFERRED EMBODIMENTS

The present invention is best understood by reference to the detailed figures and description set forth herein.

Embodiments of the invention are discussed below with reference to the Figures. However, those skilled in the art will readily appreciate that the detailed description given herein with respect to these figures is for explanatory purposes as the invention extends beyond these limited embodiments. For example, it should be appreciated that those skilled in the art will, in light of the teachings of the present invention, recognize a multiplicity of alternate and suitable approaches, depending upon the needs of the particular application, to implement the functionality of any given detail described herein, beyond the particular implementation choices in the following embodiments described and shown. That is, there are numerous modifications and variations of the invention that are too numerous to be listed but that all fit within the scope of the invention. Also, singular words should be read as plural and vice versa and masculine as feminine and vice versa, where appropriate, and alternative embodiments do not necessarily imply that the two are mutually exclusive.

It is to be further understood that the present invention is not limited to the particular methodology, compounds, materials, manufacturing techniques, uses, and applications, described herein, as these may vary. It is also to be understood that the terminology used herein is used for the purpose of describing particular embodiments only, and is not intended to limit the scope of the present invention. It must be noted that as used herein and in the appended claims, the singular forms “a,” “an,” and “the” include the plural reference unless the context clearly dictates otherwise. Thus, for example, a reference to “an element” is a reference to one or more elements and includes equivalents thereof known to those skilled in the art. Similarly, for another example, a reference to “a step” or “a means” is a reference to one or more steps or means and may include sub-steps and subservient means. All conjunctions used are to be understood in the most inclusive sense possible. Thus, the word “or” should be understood as having the definition of a logical “or” rather than that of a logical “exclusive or” unless the context clearly necessitates otherwise. Structures described herein are to be understood also to refer to functional equivalents of such structures. Language that may be construed to express approximation should be so understood unless the context clearly dictates otherwise.

Unless defined otherwise, all technical and scientific terms used herein have the same meanings as commonly understood by one of ordinary skill in the art to which this invention belongs. Preferred methods, techniques, devices, and materials are described, although any methods, techniques, devices, or materials similar or equivalent to those described herein may be used in the practice or testing of the present invention. Structures described herein are to be understood also to refer to functional equivalents of such structures. The present invention will now be described in detail with reference to embodiments thereof as illustrated in the accompanying drawings.

From reading the present disclosure, other variations and modifications will be apparent to persons skilled in the art. Such variations and modifications may involve equivalent and other features which are already known in the art, and which may be used instead of or in addition to features already described herein.

Although Claims have been formulated in this Application to particular combinations of features, it should be understood that the scope of the disclosure of the present invention also includes any novel feature or any novel combination of features disclosed herein either explicitly or implicitly or any generalization thereof, whether or not it relates to the same invention as presently claimed in any Claim and whether or not it mitigates any or all of the same technical problems as does the present invention.

Features which are described in the context of separate embodiments may also be provided in combination in a single embodiment. Conversely, various features which are, for brevity, described in the context of a single embodiment, may also be provided separately or in any suitable subcombination. The Applicants hereby give notice that new Claims may be formulated to such features and/or combinations of such features during the prosecution of the present Application or of any further Application derived therefrom.

References to “one embodiment,” “an embodiment,” “example embodiment,” “various embodiments,” etc., may indicate that the embodiment(s) of the invention so described may include a particular feature, structure, or characteristic, but not every embodiment necessarily includes the particular feature, structure, or characteristic. Further, repeated use of the phrase “in one embodiment,” or “in an exemplary embodiment,” do not necessarily refer to the same embodiment, although they may.

As is well known to those skilled in the art many careful considerations and compromises typically must be made when designing for the optimal manufacture of a commercial implementation any system, and in particular, the embodiments of the present invention. A commercial implementation in accordance with the spirit and teachings of the present invention may configured according to the needs of the particular application, whereby any aspect(s), feature(s), function(s), result(s), component(s), approach(es), or step(s) of the teachings related to any described embodiment of the present invention may be suitably omitted, included, adapted, mixed and matched, or improved and/or optimized by those skilled in the art, using their average skills and known techniques, to achieve the desired implementation that addresses the needs of the particular application.

It is to be understood that any exact measurements/dimensions or particular construction materials indicated herein are solely provided as examples of suitable configurations and are not intended to be limiting in any way. Depending on the needs of the particular application, those skilled in the art will readily recognize, in light of the following teachings, a multiplicity of suitable alternative implementation details.

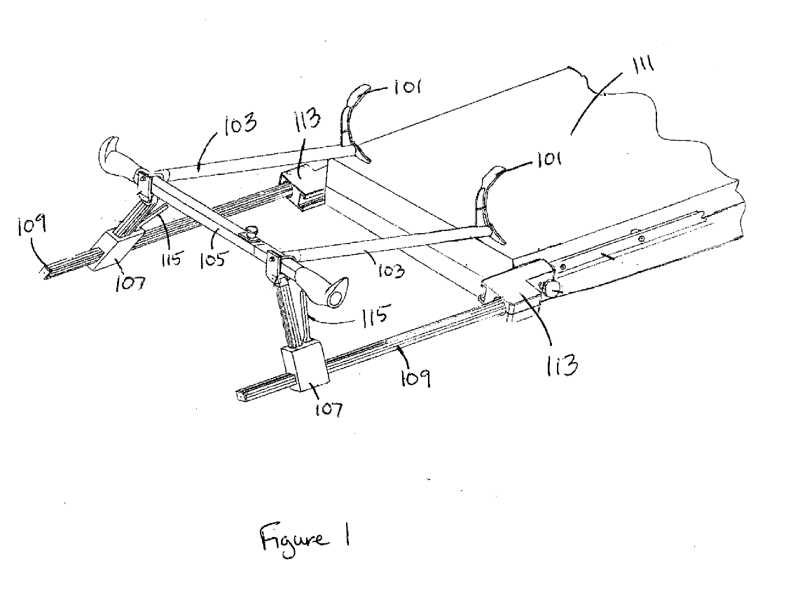

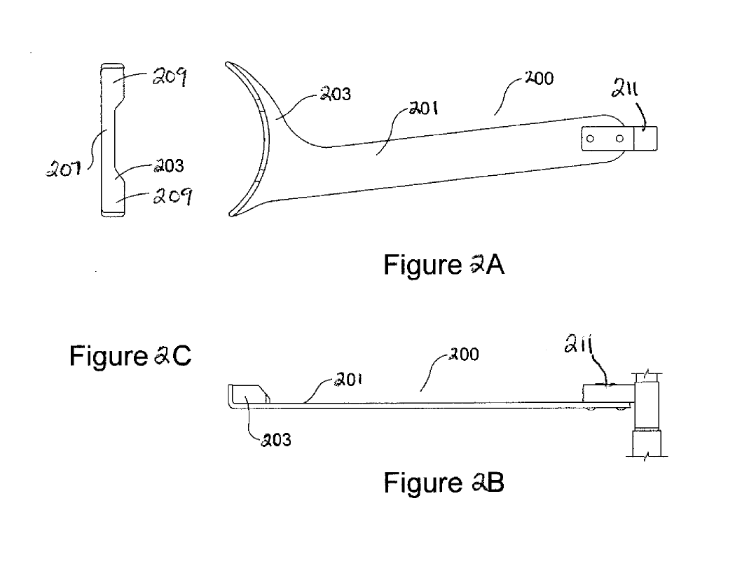

FIG. 1 is a side perspective view of an exemplary means for positioning the shoulders of a subject for improved lateral imaging of the cervical vertebral structures. In the present embodiment, offset arches 101 on the ends of pusher tubes 103 are used with a crossbar 105 to create a shoulder press to migrate the shoulders of a subject distally to allow for improved radiographic lateral views during cervical vertebral surgical and diagnostic procedures. Offset arches 101 and pusher tubes 103 are preferably constructed of radiographically invisible, or radiolucent, material, in order to deliver a platform for distal migration of the subject's acromionclavicular joint that does not appear on radiographic imaging. In some alternate embodiments, this pusher tube and arch assembly may be replaced by a one-piece arm made of high strength laminar sheeting that terminates in a variable geometric arch, as shown by way of example in FIGS. 2A through 2C. In the present embodiment, the shoulder press is utilized as a component of a table mounted system that comprises a rail guided braking system to provide distal migratory pressure and a hands free locking function. In this system, crossbar 105 is adjustable in width and is cradled into variably positionable table mounted rail guides 107 by the automatic hands free locking system. The adjustability of crossbar 105 enables arches 101 to be placed directly on the acromionclavicular joint of the subject during use. Rail guides 107 slide along rails 109 that are mounted to a table 111 by mounting means 113 such as, but not limited to clamps, bolts, hooks, etc. Triggers 115 control the locking system by controlling the brakes within rail guides 107. In the present embodiment the following mechanism describes an exemplary braking mechanism without limitation to said mechanism, The Exemplary Braking Mechanism comprises, but not limited to, a toothed rack fitted within the rail guide assembly, such that bidirectional free travel is permitted while the operator grips the spring loaded trigger actuator mechanism, thereby lifting and holding the locking pin above the toothed rack assembly. Brake actuation is affected via release of the trigger by the operator, thereby allowing the metallic or non metallic spring to force the locking pin into immediate rigid interface with the toothed rack assembly, restricting all motion, until such time as trigger actuation via the operator effects release of said rigid interface thru the lifting of the locking pin from the toothed rack assembly, thereby restoring free motion. In alternative embodiments, various friction and caliper braking mechanisms may be employed such as, but not limited to, bicycle or motorcycle disc or drum or caliper brakes arranged so as to replicate the above braking function with equivalent trigger actuation, as well as braking mechanisms which operate upon various mechanical means well known to one skilled in the art, to include, but not be limited to mechanical cone brakes, hydraulic braking systems, hydraulic clutches, mechanical clutches, pneumatic brakes, pneumatic clutches, friction/disc clutches, spring clutches, sprag clutches, roller ramp, electromagnetic clutches, gear drives, chain drives, etc. The means may involve, yet not be limited to, friction, wrap spring, oil shear, toothed surface, as well as non contact methods. Triggers 115 enable rail guides 107 to slide along rails 109 when engaged by a user and lock rail guides 107 in place when released by the user. Therefore, the shoulder press may be positioned on a subject and held in place by the locking system to deliver temporary distal migratory pressure directly to the structures of the acromionclavicular joint for proper intra-operative radiographic visualization of the structures of the cervical vertebral column without the aid of the user, such that nobody save the subject is subjected to radiation exposure during imaging.

FIGS. 2A, 2B and 2C illustrate an exemplary one-piece shoulder pusher 200, in accordance with an embodiment of the present invention. FIG. 2A is a diagrammatic side view. FIG. 2B is a diagrammatic top view, and FIG. 2C is a diagrammatic front view. In the present embodiment, shoulder pusher 200 is a one-piece radiolucent anatomic positioning device for migrating the shoulders of a subject distally for improved radiographic lateral views during cervical vertebral surgical and diagnostic procedures. Shoulder pusher 200 is preferably made of radiographically invisible, high strength laminar sheeting in the form of an asymmetrically offset tapered arm 201 terminating in a variable thickness, geometric arch 203, in order to deliver the necessary platform for distal migration of a subject's acromionclavicular joint. In the present embodiment, shoulder pusher 200 is preferably made of carbon, however, alternate embodiments may be made of various different radiolucent materials such as, but not limited to, carbon fiber, PEEK, beryllium, glass fiber reinforced acrylic, thermoplastics, polycarbonates, polyketones, etc. Tapered arm 201 is asymmetrically positioned at the lower portion of arch 203 and is slightly angled. This positioning of tapered arm 201 generally eliminates the artifact that may be caused by a symmetrical shoulder pusher, which typically directly overlays the vertebral column when in use, while enabling a user to transmit the necessary motive force to migrate the shoulders. Alternate embodiments may be implemented where the tapered arm is positioned at the top of the arch. In the present embodiment, the reduced density of the thin yet strong combination of the radiolucent structures into one low density sheet renders shoulder pusher 200 virtually free of artifact in various different imaging environments.

Referring to FIGS. 2B and 2C, the thickness of shoulder pusher 200 varies throughout its structure, particularly at arch 203. This enables the density of shoulder pusher 200 to be lower over key anatomical features to be visualized while still preserving the mechanical integrity necessary to efficiently and comfortably migrate the shoulders. For example, without limitation, referring to FIG. 2C, a middle portion 207 of arch 203 is thinner than outer portions 209. This enables arch 203 to be thick enough where needed to comfortably migrate a subject's shoulders without the excessive pressure that would be caused by a uniformly thin arch while providing low density in the area over the cervical vertebrae. Those skilled in the art, in light of the present teachings, will readily recognize that the variance in density of the structure of the shoulder pusher may be different in alternate embodiments. For example, without limitation, one alternate embodiment may have a uniform thin density except for a thickened edge, similar to a lip, along the arch where the shoulder pusher comes into contact with the subject. Some embodiments may be implemented to view specific portions of the subject's anatomy, for example, without limitation, one such embodiment may have a thicker density near the arch and a lower density away from the arch in order to obtain radiographic images of the higher cervical vertebrae. Some embodiments may include padding along the edge of the arch for the comfort of the subject.

Referring to FIG. 2A, in the present embodiment, arch 203 has an eccentric curvilinear design that also contributes to the low density of shoulder pusher 200. Alternate embodiments of the present invention may have eccentric arches of various different shapes and sizes to accommodate a variety of subjects, such that the density reduction methodologies described herein may be applied to various anatomical structures outside of the cervical vertebral bodies, while still utilizing the single piece planar composition of radiolucent material combined with the eccentric geometry of the variable density arch. One practical embodiment of the variable density arch employs variation in the structural geometry of the arch itself in order to minimize radiographic artifact while still preserving crucial structural strength and integrity. The geometry principles taught by way of example can readily be applied to other portions of the anatomy with relatively strait forward modifications specific to the structures needing to be visualized radiographically. Furthermore some alternate embodiments may be implemented without an eccentric arch, but with a variable density, eccentric curvilinear segments of polygon which most specifically attend to the essential requirements of radiographic visualization. The polygons by way of example, without limitation, may include ovals, triangles, trapezoids, etc. In the present embodiment, shoulder pusher 200 comprises attachment means 211 to enable shoulder pusher 200 to be attached to a connection tube, a handle, a table mount, or other such equipment that aids in the use of shoulder pusher 200.

Referring to FIGS. 1 through 2C, a positioning system according to an embodiment of the present invention combines a table mounted positioning system according to FIG. 1 with two one-piece radiolucent shoulder pushers 200 of variable thickness according to FIGS. 2A through 2C in place of arches 101 and pusher tubes 103 to improve upon traditional positioning means via positioning arches 203 directly atop the subject's acromionclavicular joint, such that the joint migrates distally rather than the entire patient. Furthermore, using this system, a user is able to release all pressure exerted on the subject by arches 203 as soon as the radiographic imagery is completed by releasing rail guides 107 of the braking system with triggers 115, thereby limiting distal migration to mere minutes as opposed to hours. This table mounted positioning system generally provides improved lateral radiographic images of the cervical vertebral structures in comparison to traditional means with little incidence of the concomitant risks of brachial plexus insult or injury and palsy that are commonplace with traditional means.

An embodiment of the present invention and at least one variation thereof provides a low profile, rigid radiolucent anatomical positioner attached to a table mounted, rail guided braking system with a variable width and height adjustment mechanism. Many embodiments are implemented without a crossbar to reduce interference caused by the positioning system and to increase access to the subject.

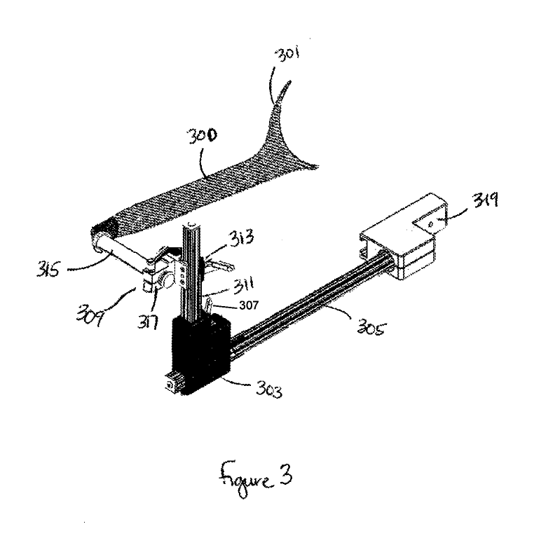

FIG. 3 is a side perspective view of an exemplary shoulder positioning device for improved lateral imaging of the cervical vertebral structure of a subject, in accordance with an embodiment of the present invention. In the present embodiment, the positioning device combines a rigid radiolucent shoulder pusher 300 terminating in an arch 301 of varying thickness with a table mounted, rail guided braking system to provide temporary, variable, rigid, radiolucent positioning directly to the acromionclavicular joint of the subject. The positioning device is implemented without a crossbar, which generally eliminates incompatibilities with patient skull clamps and difficulties with access to the subject. In the present embodiment, shoulder pusher 300 is preferably made of a rigid radiolucent material so as not to block the view of the cervical vertebrae when obtaining a lateral image. Some non-limiting examples of rigid radiolucent materials that may be used to construct shoulder pusher 300 include, without limitation, carbon, carbon fiber, PEEK, berylium, glass fiber, reinforced acrylics, thermoplastics, polycarbonates, polyketones, etc. In some embodiments, arch 301 may be padded for the comfort of the subject.

In the present embodiment, the table mounted braking system comprises a rail guided braking mechanism 303 on a guide rail 305. A trigger 307 enables braking mechanism 303 to be locked into place on guide rail 305 or to be released from guide rail 305. When trigger 307 is held down by a user, braking mechanism 303 is able to slide along guide rail 305, and when trigger 303 is released, the brake is engaged and braking mechanism 303 is held securely in place on guide rail 305. The braking system allows for the hands free usage of the positioning device during radiography, with quick release of all distal migratory tension to the shoulders of the subject via the simple tapping of trigger 307. Those skilled in the art, in light of the present teachings, will readily recognize that a multiplicity of alternate and suitable types of locking means may be used in alternate embodiments to hold the device in place on the guide rail such as, but not limited to, a ratcheting rack and pinion with a crank, various types of clamps, pins, etc. Furthermore, actuation means other than triggers may be used to control the braking mechanism in alternate embodiments such as, but not limited to, buttons, spring loaded knobs, dials, etc. In the present embodiment, automatic trigger actuation of the braking system is effected as soon as the operator releases said triggers as previously described. In some alternative embodiments, the braking mechanism may be actuated via active means, such that activation is not automatic, but rather, requires the intentional activation of, but not limited to, a lever, a knob, a set screw, a pin, a dial, a trigger, a switch, a clutch, etc.

In the present embodiment, shoulder pusher 300 is attached to braking mechanism 303 with a variable width and height adjustment mechanism 309. To adjust the height of shoulder pusher 300, adjustment mechanism 309 slides up and down on a vertical rail 311. Once shoulder pusher 300 is at the correct height, adjustment mechanism is secured into place with a clamp 313. Those skilled in the art, in light of the present teachings, will readily recognize that a multiplicity of suitable means may be used to adjust the height of the arch in alternate embodiments, such as, but not limited to, a perforated rail and sliding mechanism that is held in place with a pin, a notched rail and sliding mechanism with a spring loaded pin, pneumatic or hydraulic mechanisms, etc. In the present embodiment, the distance of shoulder pusher 300 from braking mechanism 303 is adjusted by sliding a rod 315 attached to shoulder pusher 300 through a clamp 317 on adjustment mechanism 309. Again, it will be readily recognized by those skilled in the art, in light of the present teachings, that various different adjustment means may be used in alternate embodiments such as, but not limited to, a pin that may be inserted into one of a multiplicity of holes on the rod, a threaded rod that may be screwed into or out of a threaded piece on the adjustment mechanism or on the vertical rail, a telescoping rod, etc. In the present embodiment, the angle of shoulder pusher 300 may also be adjusted by rotating rod 315. Some alternate embodiments may be implemented in which the shoulder pusher is not adjustable or adjustable in fewer directions. For example, without limitation, in one non-adjustable embodiment, the shoulder pusher is directly attached to the braking mechanism by a fixed connection rod. In another alternate embodiment, only the height of the shoulder pusher is adjustable, and in yet another alternate embodiment, only the distance of the shoulder pusher from the braking mechanism is adjustable. In the present embodiment, guide rail 305 is attached to a patient platform such as, but not limited to, a surgical table or an imaging table with a clamp 319; however, alternate embodiments may use various different attachment means such as, but not limited to, bolts, screws, hooks, etc. Some alternate embodiments may be permanently attached to the patient platform.

In typical use of the present embodiment, a subject is placed on a patient platform on which the shoulder positioning device is attached. The position of shoulder pusher 300 is adjusted so that arch 301 is placed directly on the acromionclavicular joint of the subject. The positioning device is typically used to migrate the shoulder of a subject toward the subject's feet in a pushing mode. In the pushing mode, a user migrates the shoulder of the subject by holding down trigger 307 and pushing braking mechanism 303 distally until the shoulder is properly migrated. The positioning device according to the present embodiment enables the user to provide direct, targeted, focused, and temporary migratory pressure of preferably 12 to 14 pounds to the subject's shoulder, which is clinically proven as an effective amount of pressure for this application. In alternate embodiments, braking mechanism 303 may further comprise force sensors and displays for monitoring the amount of force being applied to the subject's shoulder. Once the shoulder is properly migrated, the user releases trigger 307 to engage locking mechanism 303 and locks the device into place. A clear lateral image of the cervical vertebral structures may then be obtained. Trigger 307 also enables the user to quickly and easily adjust the amount of pressure exerted by arch 301 or to release the subject as needed during the procedure for various reasons such as, but not limited to, emergency situations or to give the subject a break. Some embodiments may comprise a quick release mechanism for the braking mechanism so that the device may be immediately removed from the subject in case of an emergency. Once the imaging is complete, the user squeezes trigger 307 and pulls back on braking mechanism 303 to release the subject, and the shoulder returns to its natural position. Thus, the subject is only subjected to the distal migratory pressure during the lateral imaging, which may be as little as 1 to 2 minutes.

In the present embodiment, the positioning device works with the anatomy of the subject in order to provide migration of the shoulder, without migrating the entire body of the subject. The acromionclavicular joint is designed by nature to migrate distally. With proper usage of this system, arch 301 makes direct contact with this joint and transfers all distal motive energy directly to this joint via rigid positioning as opposed to straps that merely compress soft tissue or harnesses that pull the entire body or compress the trapezius muscle, which is not the source of a typical obscuring artifact during lateral radiography of the cervical vertebral structures. Furthermore, the present embodiment typically does not interfere with other medical equipment that may be in use on the patient platform such as, but not limited to, skull clamps and generally does not restrict access to the subject.

In typical use of the present embodiment two shoulder positioning devices are used in tandem as a mirror imaged set for purposes of simultaneous positioning of the shoulders to optimize the radiographic visualization of the cervical vertebral structures. Alternatively, the shoulder positioning devices may be used independently from each other to migrate the shoulders to different degrees, for example, without limitation, for facilitating the “swimmers view” to diagnose suspected subluxation (i.e., breakage) of the cervical vertebral structures. In another alternative use, one shoulder positioning device may be used alone to migrate a single shoulder.

In alternate embodiments, shoulder positioning devices may be configured for use in a pulling mode or an encircling mode for various usages where radiographic anatomical positioning may be necessary for example, without limitation, MRI compatible anatomic limb positioning, scoliosis positioning, diagnostic positioning, etc. In an alternate embodiment implemented for use in the pulling mode, where the device is fashioned to transmit proximal migratory pressure for purposes of rigid radiolucent positioning, the direction of the arch is reversed such that the arch may be pulled to move the shoulders proximally as opposed to being pushed distally. This embodiment may be useful in many practical applications including, but not limited to, clinical and diagnostic radiographic applications in emergent trauma in the emergency room. In an alternate embodiment implemented for use in the encircling mode, in which the limb to be positioned is encircled by the positioning means, two arches are used in tandem on the limb in order to encircle it. Alternatively, the arch may be altered to be able to be placed around the limb. In some encircling embodiments, the arch may be eliminated in favor of a padded strap or a harness.

It is contemplated that some alternate embodiments may be implemented in which various components of the shoulder positioning device are ergonomically designed. For example, without limitation, the trigger and brake mechanism in one alternate embodiment may be encased in a rubberized grip with ergonomic features such as, but not limited to, finger grooves and curved edges. In another alternate embodiment, the adjustment clamps may have large ergonomic dials that allow for easy operation.

In yet other alternate embodiments, some or all of the mechanical movements of the positioning device may be achieved through the use of motors. For example, without limitation, in one alternate embodiment, a motor on the braking mechanism moves the braking mechanism along the guide rail distally to exert the desired distal pressure to the acromionclavicular joint or proximally to relieve this pressure. In another alternate embodiment the adjustment of the positioning of the shoulder pusher may be accomplished by motors controlling the adjustment mechanism. These motors may be controlled at the table or remotely. Other alternate embodiments may control motors using a computing device with inputs from force sensors. In other alternate embodiments, the computing device may be remote using a wireless connection to motors and sensors. In yet other alternate embodiments, the computing device may work in conjunction with the imaging apparatus to apply the force only when needed.

Those skilled in the art, in light of the present teachings, will readily recognize that alternate embodiments of the present invention may be implemented for the positioning of various different portions of a subject's anatomy. For example, without limitation, in one alternate embodiment, a table mounted braking system along with an arch can readily be adapted as a vertical positioner for the leg for purposes such as, but not limited to, hip arthroplasty. Vertical positioning of the lower extremities can be effected via proximal migration of the table mounted rail guide arranged with straps secured to an arch with disposable padding, in such a manner as to capture the back of the thigh as it intersects with the natural bend of the knee. Proximal migration of the table mounted braking system has the effect of raising the leg into an upright position. Alternatively, an arch on a rigid arm may be extended upward from rail guides near the foot of the table to hold the thigh without the use of straps. A vertical stabilizer bar may be positioned in such a way as to rise perpendicularly to the rail guide so as to generally prevent lateral motion of the limb. The table mounted braking system locks automatically when released, thereby affecting the full spectrum of adjustability.

In another alternate embodiment, by mounting the rail guide transversely at the side of the table, the system, turned sideways, may have great utility as lateral hip restraints or lateral shoulder restraints for use during procedures such as, but not limited to, hip and scoliosis procedures. The arch portion in this embodiment can be readily adapted to capture the hip or shoulder of a subject who is positioned on his side. There are currently a number of hip positioners which accomplish this type of lateral hip support, via adjustable means utilizing either simple friction locks or a peg board placed under the subject with means to plug the lateral hip supports into the peg board via a peg. However, neither of these solutions have the necessary strength to accommodate a bariatric patient, nor do these means offer the ease of use and intra-operative variability that may be provided by this embodiment of the present invention.

Yet other alternate embodiments may be used as lateral positioners that may be operated with one hand to position and lock a subject into place. These embodiments involve transverse placement of the table mounted braking system, slight modification of the arch and a simple vertical plate equipped with a disposable pad in order to improve upon the performance and function of prior art lateral positioners, none of which offer intra-operative variability or repositioning. A multiplicity of usages of these embodiments as lateral anatomic rigid radiolucent positioners will be readily apparent to those skilled in the art in light of the teaching of the present invention. Examples of which include, without limitation, spinal and hip positioners for usage during surgery to correct for scoliosis, pinpoint mammography, head positioners (i.e., halos) which would capture and gently fixate the subject's head in encircling radiolucent arches without percutaneous pin fixation thru the patients skin, etc.

Having fully described at least one embodiment of the present invention, other equivalent or alternative methods of providing distal migration of the shoulders according to the present invention will be apparent to those skilled in the art. The invention has been described above by way of illustration, and the specific embodiments disclosed are not intended to limit the invention to the particular forms disclosed. For example, the particular implementation of the positioning device may vary depending upon the particular type of application for which it is to be used. The positioning devices described in the foregoing were directed to implementations for use in imaging environments; however, similar techniques are to provide positioning devices that may be used in various different applications such as, but not limited to, the immobilization of a subject with a suspected neck or back injury, traction, physical therapy, etc. It should be appreciated by those skilled in the art that these non-imaging embodiments may or may not comprise radiolucent materials. Non-imaging implementations of the present invention are contemplated as within the scope of the present invention. The invention is thus to cover all modifications, equivalents, and alternatives falling within the spirit and scope of the following claims.

Claim elements and steps herein may have been numbered and/or lettered solely as an aid in readability and understanding. Any such numbering and lettering in itself is not intended to and should not be taken to indicate the ordering of elements and/or steps in the claims.

What is claimed is:

1. An apparatus comprising:
a first anatomic positioner for migrating a first anatomic part of a patient on a patient platform, said first anatomic positioner comprising:
a mechanism for joining the apparatus to a first side of the patient platform;
a support member being joined to said mechanism and being configured to extend generally longitudinally along the first side;
a breaking assembly being configured to be operable to move longitudinally along said support member, said breaking assembly being further configured to be operable to be fixed at a position along said support member;
a support assembly being joined to said breaking assembly, said support assembly being configured to extend away from said breaking assembly and above a top of the patient platform, said support assembly being further configured to be operable to position at least a portion of said support assembly at a location above the top and to fix said portion at said location; and
a rigid member comprising a first end portion and an engaging end distal to said first end portion, said first end portion being joined to said portion of said support assembly, said engaging end being configured to be operable for engaging the first anatomic part and applying a pushing force thereupon where, with said engaging end positioned to engage, said support assembly fixed, and said breaking assembly moved, the force is applied to migrate the first anatomic part.

2. The apparatus as recited in claim 1, in which said engaging end of said rigid member comprises an arch shape.

3. The apparatus as recited in claim 1, in which said engaging end comprises an arch with an eccentric curvilinear shape.

4. The apparatus as recited in claim 1, in which said breaking mechanism comprises a trigger mechanism for removably fixing at a position.

5. The apparatus as recited in claim 1, in which said support assembly further comprises a first member for extending away from said breaking assembly and a second member for extending across a portion of the top.

6. The apparatus as recited in claim 5, in which said support assembly further comprises an adjustment mechanism joining said first member and said second member.

7. The apparatus as recited in claim 6, in which said adjustment mechanism is configured to be operable to move along a longitudinal axis of said first member and a longitudinal axis of said second member.

8. The apparatus as recited in claim 7, in which said second member is rotatably joined to said adjustment mechanism.

9. The apparatus as recited in claim 1, in which said rigid member further comprises a radiolucent material.

10. The apparatus as recited in claim 1, in which said engaging end is further configured to be operable for engaging an acromioclavicular joint and caudally migrating the acromioclavicular joint.

11. The apparatus as recited in claim 1, further comprising a second anatomic positioner for migrating a second anatomic part of a patient on the patient platform, said second anatomic positioner comprising a mirror image of said first anatomic positioner, said second anatomic positioner being joined to a second side of the patient platform.

12. An apparatus comprising:
a first anatomic positioner for caudally migrating a first acromioclavicular joint of a patient on a patient platform, said first anatomic positioner comprising:
means for joining the apparatus to a first side of the patient platform;
means, being joined to said joining means, for extending generally longitudinally along the first side;
means for moving along a longitudinal axis of said extending means and for removably fixing at a position along said extending means;
means, being joined to said moving means, for positioning a portion at a location above a top of the patient platform and for removably fixing said portion at said location; and
means, being joined to said portion, for engaging the first acromioclavicular joint and for applying a pushing force thereupon where, with said moving means moved in a caudal direction, the force is applied to caudally migrate the first acromioclavicular joint; and
a second anatomic positioner for caudally migrating a second acromioclavicular joint of the patient, said second anatomic positioner comprising:
means for joining the apparatus to a second side of the patient platform;
means, being joined to said joining means, for extending generally longitudinally along the second side;
means for moving along a longitudinal axis of said extending means and for removably fixing at a position along said extending means;
means, being joined to said moving means, for positioning a portion at a location above the top of the patient platform and for removably fixing said portion at said location; and
means, being joined to said portion, for engaging the second acromioclavicular joint and for applying a pushing force thereupon where, with said moving means moved in a caudal direction, the force is applied to caudally migrate the second acromioclavicular joint to provide a clear radiographic lateral imaging of the cervical vertebral structures of the patient.

13. An apparatus comprising:
a first anatomic positioner for caudally migrating a first acromioclavicular joint of a patient on a patient platform, said first anatomic positioner comprising:
a mechanism for joining the apparatus to a first side of the patient platform;
a support member being joined to said mechanism and being configured to extend generally longitudinally along the first side;
a breaking assembly comprising a break mechanism, said breaking assembly being configured to move along a longitudinal axis of said support member, said break mechanism being configured to be operable to removably fix said breaking assembly at a position along said support member;
a support assembly being joined to said breaking assembly, said support assembly comprising a first member for extending away from said breaking assembly and a second member for extending across a portion of the top, said support assembly being further configured to be operable to position a portion of said second member at a location above the top and to removably fix said portion at said location; and
a rigid member comprising a radiolucent material and comprising a first end portion and an arch distal to said first end portion with an eccentric curvilinear shape, said first end portion being joined to said portion of said second member, said arch being configured to be operable for engaging the first acromioclavicular joint and applying a pushing force thereupon where, with said arch positioned to engage, said support assembly fixed, and said breaking assembly moved in a caudal direction, the force is applied to caudally migrate the first acromioclavicular joint; and
a second anatomic positioner for caudally migrating a second acromioclavicular joint of the patient, said second anatomic positioner comprising:
a mechanism for joining the apparatus to a second side of the patient platform;
a support member being joined to said mechanism and being configured to extend generally longitudinally along the second side;
a breaking assembly comprising a break mechanism, said breaking assembly being configured to move along a longitudinal axis of said support member, said break mechanism being configured to be operable to removably fix said breaking assembly at a position along said support member;
a support assembly being joined to said breaking assembly, said support assembly comprising a first member for extending away from said breaking assembly and a second member for extending across a portion of the top, said support assembly being further configured to be operable to position a portion of said second member at a location above the top and to removably fix said portion at said location; and
a rigid member comprising a radiolucent material and comprising a first end portion and an arch distal to said first end portion with an eccentric curvilinear shape, said first end portion being joined to said portion of said second member, said arch being configured to be operable for engaging the second acromioclavicular joint and applying a pushing force thereupon where, with said arch positioned to engage, said support assembly fixed, and said breaking assembly moved in a caudal direction, the force is applied to caudally migrate the second acromioclavicular joint to provide a clear radiographic lateral imaging of the cervical vertebral structures of the patient.

14. The apparatus as recited in claim 13, in which said break mechanism comprises a trigger mechanism for operating said break mechanism.

15. A method of using the apparatus of claim 1, the method comprising steps of:
joining said joining mechanism of said first anatomic positioner to the side of the patient platform;
moving said breaking assembly in a cranial direction to an end of said support member;
operating said support assembly to position said engaging end of said rigid member to engage the first anatomic part;
fixing said position of said support assembly;
pushing on said breaking assembly to caudally migrate the first anatomic part; and
fixing the position of said breaking assembly when the first anatomic part has been migrated.

16. The method as recited in claim 15, further comprising the step of placing an arch of said engaging end on a shoulder area of the patient above an acromioclavicular joint.

17. The method as recited in claim 15, further comprising the step of operating a trigger mechanism for fixing a position of said breaking assembly.

18. The method as recited in claim 15, further comprising steps of:
joining a joining mechanism of a second anatomic positioner to a second side of the patient platform;
moving a breaking assembly of said second anatomic positioner in a cranial direction to an end of a support member of said second anatomic positioner;
operating a support assembly of said second anatomic positioner to position an engaging end of a rigid member of said second anatomic positioner to engage a second anatomic part;
fixing said position of said support assembly of said second anatomic positioner;
pushing on said breaking assembly of said second anatomic positioner to caudally migrate the second anatomic part; and
fixing a position of said breaking assembly of said second anatomic positioner when the second anatomic part has been migrated.

19. The method as recited in claim 18, further comprising the step of placing an arch of said engaging end of said rigid member of said second anatomic positioner on a second shoulder area of the patient above a second acromioclavicular joint.

20. The method as recited in claim 18, further comprising the step of operating a trigger mechanism of said second anatomic positioner for fixing a position of said breaking assembly of said second anatomic positioner.
